(19) United States
(12) Patent Application Publication
(10) Pub. No.: US 2023/0167601 A1
(43) Pub. Date: Jun. 1, 2023

(54) ANTIMICROBIAL TEXTILES

(71) Applicant: BASF Corporation, Florham Park, NJ (US)

(72) Inventors: Ted W. DEISENROTH, Tarrytown, NY (US); Carmen A. HENDRICKS-GUY, Tarrytown, NY (US); Glen CUNKLE, Tarrytown, NY (US)

(21) Appl. No.: 17/922,008

(22) PCT Filed: Apr. 30, 2021
(86) PCT No.: PCT/US2021/030167

§ 371 Date: Oct. 28, 2022

Related U.S. Application Data
(60) Provisional application No. 63/114,449, filed on Nov. 16, 2020.
(60) Provisional application No. 63/017,980, filed on Apr. 30, 2020.

(51) Int. Cl. D06M 13/46; D06M 15/09; D06M 16/00; A01N 33/12

(52) U.S. Cl. CPC D06M 13/46; D06M 15/09; D06M 16/00; A01N 33/12

(57) ABSTRACT

A stable aqueous dispersion containing a mixture of an anionic polymer, quaternary ammonium salt, a dispersion agent and water. The dispersing agent is poly (acrylamide-co-acrylic acid) or copolymer of maleic acid and an olefin. The dispersion can be applied to textile materials and nonwoven substrates. Nonwoven substrates, such as polypropylene substrates can be treated with the dispersion to provide a highly active quick killing antimicrobial effect: Log 4 reduction in 5 minutes. This would be useful to deactivate the SARS-CoV-2 virus, which causes Covid-19.

### CROSS-REFERENCE TO RELATED APPLICATIONS

This application is a national stage application (under 35 U.S.C. § 371) of PCT/US2021/030167, filed Apr. 30, 2021, which claims benefit to U.S. Provisional application No. 63/114,449, filed Nov. 16, 2020, and U.S. Provisional application No. 63/017,980, filed Apr. 30, 2020, all of which are incorporated by reference for all useful purposes.

Antimicrobial textiles, characterized by fast action against pathogens, durability and aqueous leach-resistance, and articles thereof, are prepared by treating at least one surface of the textile with a dispersion comprising an anionic polyelectrolyte, such as carboxymethyl cellulose (CMC) salt, at least one select quaternary ammonium antimicrobial agent and a dispersing agent.

### BACKGROUND OF THE INVENTION

The prevalence of nosocomial infections and viruses has serious implications for both patients and healthcare workers. Nosocomial infections are those that originate or occur in a hospital or long-term care, hospital-like settings. These hospital acquired infections (HAIs) can be quite serious and dangerous, as many of the pathogens found in healthcare settings can be resistant to typical antibiotics and thus more difficult to treat.

HAIs may develop from surgical procedures, catheters placed in the urinary tract or blood vessels, or from material from the nose or mouth that is inhaled into the lungs. For example, common HAIs include urinary tract infections, pneumonia from endo-tracheal ventilators, blood-born pathogen contaminations, and surgical wound infections.

The occurrence and spread of nosocomial infections, bacteria, fungi, yeast and viruses, such as but not limited to SARS-CoV-2, which causes Covid-19, are greatly dependent on the microbes' ability to colonize and survive within institutions, for example, on hospital gowns, surgical equipment, medical devices, gloves, bed clothes etc. Transmission of microbes from one contaminated surface to an uncontaminated surface, for example, a bed sheet, skin or an open wound, spreads the diseases. The microbes may already be present in the patient's body or may come from the environment, contaminated hospital equipment, healthcare workers, or other patients.

Hospitals and other healthcare facilities have developed programs to prevent nosocomial infections. Such programs include frequent hand washing by healthcare workers and visitors, the extensive use of masks, eye protections, face shields and gloves to prevent exposure to blood, body fluids, secretions, excretions, contaminated items, mucus membrane and non-intact skin. Gowns are worn to protect skin and avoid contamination of clothing from splashes of blood or body fluids. Medical instruments and equipment are sterilized to ensure they are not contaminated.

Despite hospital infection control programs, a significant number of infections still occur. The current procedures are not sufficient. Despite enforcement of precautionary measures (e.g. washing hands, wearing gloves, face mask and cover gowns), HAIs still occur predominately via contact transfer. That is, individuals who contact pathogen-contaminated surface such as hands, clothing and/or medical instruments, can still transfer the pathogens from one surface to another immediately or within a short time after initial contact.

For example, a surgical mask or a cover gown worn to prevent the wearer from becoming exposed to microbes is discarded immediately after use. However, any microbes transferred to the surface of the mask or gown can be transferred to any surface contacted by the discarded item, and then from that surface to another surface and so on. It is important therefore, that the microbes transferred to the mask or gown be killed before the item comes into contact with a non-protected surface. Conventional antimicrobial treatments are not typically effective enough at killing and immobilizing pathogens on such surfaces in the short period of time required, e.g., 5 minutes or less.

In addition to being lethal to pathogens, the compatibility of the antimicrobial treatment with these fabrics or material and durability of the treatment once applied must be taken into account. Loss of the antimicrobial to the environment during use or storage of the item should be prevented for efficacy to be retained and to prevent buildup of the antimicrobials in soil, water and animals etc. A successful solution should provide an antimicrobial material that is extremely fast acting in the destruction of pathogens and which will not leach the actives to the environment.

A large number of fast acting cationic antimicrobials or biocides such as quaternary ammonium salts are known but need to be specifically formulated for use in such areas as medical textile applications. For example, synthetic nonwoven textiles, such as nonwoven polypropylene fabrics, are widely used in hospital and other medical settings, yet until now the application of cationic antimicrobials to synthetic nonwoven fabrics to produce a fast acting and durable antimicrobial finish has not been realized.

The application of a charged aqueous biocide to an uncharged, nonpolar surface like a polypropylene nonwoven is difficult.

The combination of anionic polyelectrolyte CMC sodium salt with the cationic antimicrobial cetyltrimethylammonium chloride forms a water insoluble polyelectrolyte complex. This complex affords a mechanism to adhere the highly water-soluble cationic antimicrobial to the hydrophobic, non-reactive surface of polypropylene nonwoven fabrics. The application was accomplished by a two-step process where the nonwoven fabric was first treated with an aqueous solution of CMC followed by an aqueous solution of cetyltrimethylammonium chloride. This process was not deemed commercially viable, as two application steps, with a potential third step, drying step in between, would add too much cost to the final product. A one-step application needed to be developed, and formulating an aqueous dispersion of the polyelectrolyte complex was considered the best approach.

U.S. Patent application 2011/250253 “Antimicrobial Treatment of Synthetic Nonwoven Textile”, discloses in the examples a three-step process of first soaking the nonwoven fabric with CMC until completely wetted and then removing off the excess solution by padding. The fabric is then dried by heat. The resulting sheet is then sprayed with cetyltrimethylammonium chloride.

WO 2012/136757 which corresponds to U.S. Patent application 2012/0258157 “Process for the Treatment of Synthetic Textiles with Cationic Biocides” discloses in the abstract a process for the treatment of a synthetic textile (T) with a cationic biocide (B) and at least one anionic polymer (P), which comprises the step of treating the synthetic textile with an aqueous composition containing the cationic biocide (B) in a concentration (c1) and containing the anionic polymer (P) in a concentration (c2), wherein the concentrations (c1) and (c2) are selected so that the ratio (R) of negative charges of the anionic polymer (P) to the positive charges of the cationic biocide (B) is between 10:1 and 1:1, which process leads to textiles with long term biocide activity.

WO 2010/009471 which corresponds to U.S. Pat. No. 8,545,862 entitled “Polyelectrolyte complex for imparting antimicrobial properties to a substrate”, discloses in the abstract anionic polyelectrolytes are used as binding agents to reduce the solubility of cationic antimicrobial polyelectrolytes. Ionic attraction between the anionic stabilizing polyelectrolytes and the antimicrobial cationic polyelectrolytes results in formation of a polyelectrolyte complex (PEC). A treatment liquid comprising a stable colloid, suspension, dispersion, solution, coacervate, or emulsion of the PEC in an aqueous carrier is used to treat an article, thus coating, infiltrating, or infusing the PEC onto or into the article. Subsequent drying results in an antimicrobial article wherein the PEC is bound to the article and is significantly less prone, relative to either of the component polyelectrolytes, to being washed, leached, leaked, extracted, or migrated from the antimicrobial article during use, or when exposed to aqueous fluids or solvents. The antimicrobial article can be further treated with ethylene oxide which enhances its antimicrobial efficacy, its biocompatibility, and its utility in wound dressings, medical devices, clothing, etc.

### SUMMARY OF THE INVENTION

An object of the invention is to develop a stable aqueous dispersion that can be applied in a single step application for coating or spraying a textile material.

Another object of the invention is to develop a highly active antimicrobial treatment that gives unprecedented quick killing activity to synthetic nonwoven fabrics: a Log 4 reduction (i.e., 99.99% reduction) in viable bacterial count within 5 minutes of inoculation is consistently observed. Inoculation occurs when the microbes come in contact with textile. This invention would be effective against viruses including SARS-CoV-2, which causes Covid-19. Potential applications for this technology include antimicrobial fabrics for various medical textiles, antimicrobial wipes and antimicrobial filters for air filtration.

The treatment of a synthetic nonwoven, such as polypropylene nonwoven, is accomplished by applying or saturating the nonwoven with a stable aqueous dispersion of (1) an anionic polyelectrolyte, such as but not limited to a CMC salt, such as CMC sodium salt or CMC potassium salt, (2) a cationic antimicrobial quaternary ammonium salt, such as but not limited to a mono or dialkyl tri or di(methyl and/or ethyl) ammonium halides and (3) a specific dispersing agent selected from the group consisting of a) a copolymer of maleic acid and an olefin and b) poly(acrylamide co-acrylic acid). This combination of the anionic polyelectrolyte with the quaternary ammonium halide and specific dispersing agent gives a water insoluble polyelectrolyte complex which binds the highly effective, broad spectrum antimicrobial agent to the hydrophobic nonwoven surface. Throughout the specification, CMC sodium salt is referred to, but CMC potassium salt, and other CMC salts, could be used as well.

Another object of the invention is to develop a cost-effective technology to create a highly active antimicrobial surface on synthetic nonwoven fabrics. The target applications are medical textiles (medical gowns, surgical drapes, antimicrobial masks) where an antimicrobial finish can reduce the spread of harmful pathogens.

Another object of the invention is to get a targeted antimicrobial effect—quick kill Log 4 reduction within 5 minutes against pertinent organisms including Methicillin-resistant Staphylococcus aureus (MRSA) and K. pneumonia. With SARS-CoV-2, no viable virus particles are detected after 5 minutes.

Another object of the invention is to develop a stable aqueous dispersion formulated using about a 1:1 weight ratio of CMC salt to cetyltrimethylammonium chloride, with a dispersing agent selected from poly(acrylamide co-acrylic acid) or a copolymer of maleic acid and an olefin, such as Sokalan® CP9 from BASF, which is a colpolymer of maleic acid and an olefin as the sodium salt with a 12,000 molecular weight.

Another object of the invention is to construct a mask which is effective in trapping and quickly killing bacteria and viruses. The mask can be worn by healthcare professionals to help prevent the spread of harmful pathogens. In addition to being effective, the mask should also be comfortable to wear. It must not be too heavy or bulky, which would discourage its use for extended periods, and, while offering effective filtration, it must have low air flow resistance so breathing is not labored.

Another object of the invention is to treat synthetic nonwoven medical textiles with antimicrobial dispersion. Rapid killing mode of action greatly reduces the potential for transmitting harmful pathogens between patients and healthcare workers. It is ideal for hygiene sensitive applications such as surgical masks, drapes, gowns, and surgical kit wraps. It is active against both bacteria and viruses.

The invention encompasses several embodiments: an aqueous dispersion, an antimicrobial textile, a method for producing an antimicrobial textile and an article containing the antimicrobial textile.

The dispersion can come in a spray bottle, so the textile can be sprayed on location to form a coating on the textile. After spraying the dispersion on the textile, the textile would preferably require heat to cure the coating. The heating can occur in a dryer. The formulation can be applied on site, such as permanent or temporary hospitals, and applied to a material.

The following are embodiments of the invention:

Embodiment 1. An aqueous dispersion which comprises

a) 0.5 to 25% by weight of anionic polyelectrolyte,
b) 0.5 to 25% by weight quaternary ammonium salts,
c) 43 to 99% by weight water and
d) 0.05 to 6.25% by weight a dispersing agent, which is poly(acrylamide-co-acrylic acid) or copolymer of maleic acid and an olefin.

Embodiment 2. The aqueous dispersion of embodiment 1, wherein the anionic polyelectrolyte is CMC salt, preferably CMC sodium salt.

Embodiment 3. The aqueous dispersion of embodiments 1 or 2, wherein the quaternary ammonium salts are mono or dialkyl tri or di(methyl and/or ethyl) ammonium halide or alkyl di(methyl and/or ethyl) benzyl ammonium halide, wherein the alkyl or each alkyl contains 6 to 18 carbon atoms.

Embodiment 4. The aqueous dispersion of embodiment 3, wherein the alkyl di(methyl and/or ethyl) benzyl ammonium halide is alkyl dimethylbenzyl ammonium chloride (ADBAC) or the mono or dialkyl tri or di(methyl and/or ethyl) ammonium halide is cetyltrimethyl ammonium chloride and the anionic polyelectrolyte is CMC salt, preferably a CMC sodium salt.

Embodiment 5. The aqueous dispersion of any of embodiments 1-4, wherein the aqueous dispersion comprises

1 to 5% by weight of anionic polyelectrolyte, preferably CMC sodium salt,
1 to 5% by weight of the quaternary ammonium salts, preferably mono or dialkyl tri or di(methyl and/or ethyl) ammonium halide wherein the alkyl or each alkyl contains 6 to 18 carbon atoms, more preferably cetyltrimethyl ammonium chloride,
0.1 to 1% by weight of the dispersing agent and
89 to 97.9% by weight water and
wherein the ratio of quaternary ammonium salts to anionic polyelectrolyte is from 0.85:1.15 to 1.15:0.85.

Embodiment 6. The aqueous dispersion of embodiment 4, wherein the aqueous dispersion comprises

1 to 3% by weight of anionic polyelectrolyte, preferably CMC sodium salt,
1 to 3% by weight of the quaternary ammonium salts, preferably mono or dialkyl tri or di(methyl and/or ethyl) ammonium halide wherein the alkyl or each alkyl contains 6 to 18 carbon atoms, more preferably cetyltrimethyl ammonium chloride,
0.15 to 0.45% by weight of the dispersing agent and
93.5 to 97.8% by weight water and
wherein the ratio of quaternary ammonium salts to anionic polyelectrolyte is about 1:1.

Embodiment 7. An aqueous dispersion consisting essentially of

from about 0.1 to 0.3% by weight, preferably about 0.2% by weight of a dispersing agent, preferably Sokalan® CP9,
from about 1.3 to 1.4% by weight, preferably about 1.34% by weight of CMC sodium salt,
from about 1.3 to 1.4% by weight, preferably about 1.34% by weight of quaternary ammonium salts, and
water,
wherein the quaternary ammonium salt is selected from the group consisting of
1) alkyl dimethyl benzyl ammonium chloride wherein the alkyl is about 50% C12 alkyl, 30% C14 alkyl, 17% C16 alkyl and 3% C18 alkyl,
2) alkyl diethyl benzyl ammonium chloride wherein the alkyl is about 50% C12 alkyl, 30% C14 alkyl, 17% C16 alkyl and 3% C18 alkyl and
3) a mixture comprising
a) 20 to 45% by weight, preferably 25 to 40% by weight, and most preferably about 32% by weight of an alkyl dimethyl benzyl ammonium chloride wherein the alkyl contains
i) 40 to 60% by weight, preferably 45 to 55% by weight, and most preferably about 50% by weight of a C14 alkyl,
ii) 30 to 50% by weight, preferably 35 to 45% by weight and most preferably about 40% by weight of a C12 alkyl, and
iii) 2 to 18% by weight, preferably 5 to 15% by weight and most preferably about 10% by weight of a C16 alkyl;
   b) 15 to 35% by weight, preferably 20 to 30% by weight and most preferably about 24% by weight of octyl decyl dimethyl ammonium chloride,
   c) 5 to 25% by weight, preferably 8 to 16% by weight, and most preferably about 12% by weight of dioctyl dimethyl ammonium chloride,
   d) 5 to 25% by weight, preferably 8 to 16% by weight, and most preferably about 12% by weight of didecyl dimethyl ammonium chloride and
   e) 10 to 30% by weight, preferably 15 to 25% by weight, and most preferably about 20% by weight of water.

Embodiment 8. A process to make an aqueous dispersion which comprises mixing the following components:

a) 0.5 to 25% by weight of anionic polyelectrolyte,
b) 0.5 to 25% by weight of quaternary ammonium salts,
c) 43 to 99% by weight water and
d) 0.05 to 6.25% by weight a dispersing agent which is preferably poly(acrylamide-co-acrylic acid) or copolymer of maleic acid and an olefin.

Embodiment 9. The process of embodiment 8, wherein the anionic polyelectrolyte is CMC salt, preferably a CMC sodium salt.

Embodiment 10. The process of embodiments 8 or 9, wherein the quaternary ammonium salts are mono or dialkyl tri or di(methyl and/or ethyl) ammonium halide wherein the alkyl or each alkyl contains 6 to 18 carbon atoms.

Embodiment 11. The process of embodiments 8 or 10, wherein the mono or dialkyl tri or di(methyl and/or ethyl) ammonium halide is cetyltrimethyl ammonium chloride and the anionic polyelectrolyte is CMC salt, preferably a CMC sodium salt.

Embodiment 12. The process of embodiment 11, wherein the aqueous dispersion comprises

1 to 5% by weight of anionic polyelectrolyte, preferably CMC sodium salt,
1 to 5% by weight of the quaternary ammonium salts, preferably mono or dialkyl tri or di(methyl and/or ethyl) ammonium halide wherein the alkyl or each alkyl contains 6 to 18 carbon atoms, more preferably cetyltrimethyl ammonium chloride,
0.1 to 1% by weight of the dispersing agent and
89 to 97.9% by weight water and
wherein the ratio of quaternary ammonium salts to anionic polyelectrolyte is from 0.85:1.15 to 1.15:0.85.

Embodiment 13. The process of embodiment 8, wherein the aqueous dispersion comprises

1 to 3% by weight of anionic polyelectrolyte, preferably CMC salt, more preferably a CMC sodium salt,
1 to 3% by weight of the quaternary ammonium salts, preferably mono or dialkyl tri or di(methyl and/or ethyl) ammonium halide wherein the alkyl or each alkyl contains 6 to 18 carbon atoms, more preferably cetyltrimethyl ammonium chloride,
0.15 to 0.45% by weight of the dispersing agent and
93.5 to 97.8% by weight water and wherein the ratio of quaternary ammonium salts to anionic polyelectrolyte is about 1:1.

Embodiment 14. A multilayer substrate which comprises at least three layers, a top layer, a bottom layer and at least one inner layer between said top layer and said bottom layer, wherein said at least one inner layer is coated with the dispersion of any of embodiments 1-7. If there is more than one inner layer, then only one inner layer has to be coated, but more than one inner layer may also be coated.

Embodiment 15. A multilayer substrate which comprises at least three layers, a top layer, a bottom layer and at least one inner layer between said top layer and said bottom layer, wherein at least said top layer is coated with the dispersion of any of embodiments 1-7.

Embodiment 16. The multilayer substrate of embodiments 14 or 15, wherein there are at least five layers and the layers are polypropylene nonwoven layers.

Embodiment 17. A mask to protect against nosocomial infections, bacteria, fungi, yeast or viruses which comprises at least five layers, a top layer, a bottom layer and at least three inner layers between said top layer and said bottom layer, wherein at least one of said at least three inner layers is coated with the dispersion of any of embodiments 1-7.

Embodiment 18. An article which is coated or sprayed with the dispersion of any of embodiments 1-7, wherein the article is a hospital gown, surgical equipment, medical device, glove, mask or bed clothes.

Embodiment 19. A process to make a treated textile material that is effective against nosocomial infections, bacteria, fungi, yeast or viruses which comprises applying in a single step application the dispersion of any of embodiments 1-7 by coating or spraying on the textile material.

Embodiment 20. The process of embodiment 19 wherein the textile material is a hospital gown, surgical equipment, medical device, glove or mask or bed clothes.

Embodiment 21. The process of any of embodiments 19, 20 or 21, wherein the textile material comprises nonwoven polypropylene.

Embodiment 22. A process for protecting a person against nosocomial infections, bacteria, fungi, yeast or viruses which comprises contacting the person with the article of embodiment 18.

Embodiment 23. The process of any of embodiments 19, 20, 21 or 22, wherein the virus is SARS-CoV-2.

Embodiment 24. An active antimicrobial treatment which comprises coating a synthetic nonwoven fabric with the dispersion of any of embodiments 1-7, such that when bacteria, fungi, yeast or viruses comes in contact with the coated fabric, at least a Log 4 reduction in viable bacterial count occurs within 5 minutes of inoculation.

Embodiment 25. An article comprising a fabric which comprises a fiber or textile which is treated with a dispersion comprising an alkyl dimethyl benzyl ammonium chloride (ADBAC) or alkyl diethyl benzyl ammonium chloride and an anionic polyelectrolyte.

Embodiment 26. The article of embodiment 25, wherein said alkyl dimethyl benzyl ammonium chloride is present in an amount from 0.5 to 4% by weight, preferably from 1 to 2% by weight and most preferably from 1.3 to 1.4% by weight of said dispersion and the alkyl in said dimethyl benzyl ammonium chloride is about 50% C12 alkyl, 30% C14 alkyl, 17% C16 alkyl and 3% C18 alkyl.

Embodiment 27. A process for protecting a person against nosocomial infections, bacteria, fungi, yeast or viruses which comprises contacting the person with the article of embodiment 25 or 26.

Embodiment 28. An article comprising a fabric which comprises a fiber or textile which is treated with a dispersion comprising an

alkyl dimethyl benzyl ammonium chloride or alkyl diethyl benzyl ammonium chloride, an anionic polyelectrolyte and water.

Embodiment 29. The article of embodiment 28, wherein the alkyl dimethyl benzyl ammonium chloride is used and said alkyl is said alkyl dimethyl benzyl ammonium chloride is about 50% by weight C12 alkyl, 30% by weight C14 alkyl, 17% by weight C16 alkyl and 3% by weight C18 alkyl.

Embodiment 30. An article comprising a fabric which comprises a fiber or textile which is treated with a dispersion comprising

a mixture of quaternary ammonium salts,
an anionic polyelectrolyte and
water,
wherein the mixture quaternary ammonium salts comprises
a) 20 to 45%, preferably 25 to 40% and most preferably about 32% by weight of an alkyl dimethyl benzyl ammonium chloride wherein the alkyl contains
i) 40 to 60%, preferably 45 to 55% and most preferably about 50% by weight of a C14 alkyl,
ii) 30 to 50%, preferably 35 to 45% by weight and most preferably about 40% by weight of a C12 alkyl, and
iii) 2 to 18% by weight, preferably 5 to 15% by weight and most preferably about 10% by weight of a C16 alkyl;
   b) 15 to 35%, preferably 20 to 30% and most preferably about 24% by weight of octyl decyl dimethyl ammonium chloride,
   c) 5 to 25%, preferably 8 to 16% and most preferably about 12% by weight of dioctyl dimethyl ammonium chloride and
   d) 5 to 25%, preferably 8 to 16% and most preferably about 12% by weight of didecyl dimethyl ammonium chloride.

Embodiment 31. An aqueous dispersion consisting essentially of

from about 0.1 to 0.3% by weight, preferably about 0.2% by weight of a dispersing agent, preferably a sodium salt of a copolymer of maleic acid and an olefin,
from about 1.3 to 1.4% by weight, preferably about 1.34% by weight of CMC salt,
from about 1.3 to 1.4% by weight, preferably about 1.34% by weight of quaternary ammonium salts, and
water,
wherein the quaternary ammonium salt is selected from the group consisting of
1) alkyl dimethyl benzyl ammonium chloride wherein the alkyl is about 50% by weight C12 alkyl, 30% by weight C14 alkyl, 17% by weight C16 alkyl and 3% by weight C18 alkyl,
2) alkyl diethyl benzyl ammonium chloride wherein the alkyl is about 50% by weight C12 alkyl, 30% by weight C14 alkyl, 17% by weight C16 alkyl and 3% by weight C18 alkyl,
3) cetyltrimethyl ammonium chloride and
4) a mixture comprising
a) 20 to 45% by weight, preferably 25 to 40% by weight, and most preferably about 32% by weight of an alkyl dimethyl benzyl ammonium chloride wherein the alkyl contains
i) 40 to 60% by weight, preferably 45 to 55% by weight, and most preferably about 50% by weight of a C14 alkyl,
ii) 30 to 50% by weight, preferably 35 to 45% by weight and most preferably about 40% by weight of a C12 alkyl, and
iii) 2 to 18% by weight, preferably 5 to 15% by weight and most preferably about 10% by weight of a C16 alkyl;
   b) 15 to 35% by weight, preferably 20 to 30% by weight and most preferably about 24% by weight of octyl decyl dimethyl ammonium chloride,
   c) 5 to 25% by weight, preferably 8 to 16% by weight, and most preferably about 12% by weight of dioctyl dimethyl ammonium chloride and
   d) 5 to 25% by weight, preferably 8 to 16% by weight, and most preferably about 12% by weight of didecyl dimethyl ammonium chloride.

The articles “a” and “an” are used herein to refer to one or to more than one (i.e., to at least one) of the grammatical object of the article. By way of example, “an element” means one element or more than one element.

When ranges are used, all the numbers included in the range are covered. For example, if the range is from 1 to 5, would include 1, 2, 3, 4, 5 and decimals, such as 1.1, 1.2, 1.3, 1.4, 1.5, 1.6, 1.7, 1.8, 1.9 etc. When % is used, it is % by weight unless otherwise specified.

As used herein, the term “and/or” includes any and all combinations of one or more of the associated listed items. “About” as used herein when referring to a measurable value such as an amount, a temporal duration, and the like, indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters.

The above summary of the present invention is not intended to describe each disclosed embodiment or every implementation of the preset invention. The detailed description that follows more particularly exemplifies illustrative embodiments.

### DESCRIPTION OF THE FIGURES

FIG. 1 illustrates a mask according to the invention.

FIG. 2 illustrates an inhibition zone of treated fabric sample.

### DETAILED DESCRIPTION OF THE INVENTION

### The Antimicrobial Textile

The antimicrobial textile may be any textile or fabric. The textile is preferably comprised of fibers and the fibers are formed from synthetic polymers.

The synthetic polymers are normally elastic or non-elastic thermoplastics.

The synthetic polymers making up the fibers are preferably selected from the group consisting of polyolefin, polyester, polyamide, polylactic acid, polyglycolic acid and mixtures thereof.

All of the above listed polymer types, polyolefin, polyester etc., include homopolymers, copolymers, terpolymers etc. Thus, a polyolefin polymer may comprise polyethylene and polypropylene and/or styrene copolymers. The polyesters may comprise copolymers such as polyethylene terephthalate (PET) or natural polyester, e.g. polylactic acid (PLA). Sympatex (polyether and polyester material which is highly breathable) would also work. The polymer may include, polybutylene adipate terephthalate (PBAT) or polyethylene naphthalate (PEN).

Most preferably, the synthetic polymers are selected from the group consisting of polyolefin, polyester, polyamide and mixtures thereof, especially for example, polypropylene, polyethylene, polypropylene/polyethylene copolymers, PET, PEN, Nylon, PBAT, natural polyesters and the like.

Polyolefin fibers are especially preferred.

Polyolefins, for example, include polypropylene, polyethylene, copolymers of ethylene and propylene, polybutylene, styrenic polymers and copolymers, metallocene-catalyzed polyolefins and mixtures thereof. The polyolefins can be random or block copolymers or synthetic polymer blends.

Polypropylene is a particularly preferred synthetic fiber material.

The textile may be woven or nonwoven but is preferably a nonwoven. It is also preferable that the material is lightweight. For each layer, the material in the textile sheet contains preferably 10 to 40 grams per square meter.

More than one type of synthetic polymer may be present. Naturally occurring polymers may also be present. Polymer blends can be included.

### The Anionic Polyelectrolyte

The anionic polyelectrolytes are those which will form a water insoluble complex with cationic antimicrobial agent and can be naturally occurring, synthetic or synthetically modified natural polymers. These anionic polyelectrolytes include cellulose, carboxy containing cellulose derivatives such as carboxy methyl cellulose, alginic acid and pectic acid, carboxy containing polysaccharides, carboxy containing starches such as carboxy methyl or ethyl starch, synthetic polymers prepared from ethylenically unsaturated carboxylic acid monomers and the like. For example, the anionic polyelectrolytes are selected from the group consisting of CMC salt, alginic acid, polymers and copolymers of acrylic acid or methacrylic acid, polymers and copolymers of maleic acid, itaconic or crotonic acid and mixtures thereof.

The anionic polyelectrolyte is preferably CMC salt, alginic acid, poly(ethylene-co-acrylic acid) or polyacrylic acid, and most preferably CMC salt, alginic acid or poly(ethylene-co-acrylic acid).

When the polyelectrolyte is a carboxy containing cellulose, starch or alginic acid, the charge density may be expressed as degree of substitution. Thus, if the polyelectrolyte is CMC salt, the degree of substitution may range from about 0.1 to about 3.0, preferably from about 0.5 to about 1.8 or more preferably from about 0.6 to about 1.4.

The weight average molecular weight (M_{w}) of the anionic polyelectrolyte is typically about 1,000 to about 5,000,000 Daltons, preferably about 10,000 to about 2,000,000 Daltons, and most preferably about 25,000 to about 500,000 Daltons.

The M_{w} can be determined by a GPC (gel permeation chromatography) method.

More than one anionic polyelectrolyte may be used. Combinations of synthetic and carboxy containing natural polymers are envisioned as the anionic polyelectrolyte. Combinations of several synthetic anionic polyelectrolytes are possible. The amount of the anionic polyelectrolyte is used in an amount from 0.5 to 25% by weight, preferably from 1 to 5% by weight, more preferably 1 to 3% by weight and most preferably about 1.3% by weight. The weight % is based on the total weight of the dispersion.

### The Cationic Antimicrobial

The cationic antimicrobial embraces quaternary ammonium salts. The quaternary ammonium salts (Quats) can be from one or more of the four following groups:

Group I. The alkyl or hydroxyalkyl (straight chain), or benzyl, substituted Quats. The alkyl can be based on one, two, three four or five different alkyls such as but not limited to a C10, C12, C14, C16, C18 and/or C20 alkyl. For example, Group I includes cetyltrimethyl ammonium chloride or an alkyl di(methyl and/or ethyl) benzyl ammonium chloride wherein the alkyl could contain four different alkyl groups such as but not limited to:
40 to 60% by weight, preferably 45 to 55% by weight and most preferably about 50% by weight of a C12 alkyl;
20 to 40% by weight, preferably 25 to 35% by weight and most preferably about 30% by weight of a C14 alkyl;
10 to 30% by weight, preferably 15 to 24% by weight and most preferably about 17% by weight of a C16 alkyl and
1 to 8% by weight, preferably 2 to 5% by weight and most preferably about 3% by weight of a C18 alkyl.

Group II. The non-halogenated benzyl substituted Quats (includes hydroxybenzyl, ethylbenzyl, hydroxyethybenzyl, napthylmethyl, dodecylbenzyl, and alkyl benzyl).

Group III. The di- and tri-chlorobenzyl substituted Quats.

Group IV. Quats with unusual substituents (charged heterocyclic ammonium compounds).

The invention also includes mixtures of any of the quaternary ammonium salts from any of Groups I-IV.

A mixture, for example, can be but is not limited to:

a) 20 to 45%, preferably 25 to 40% and most preferably about 32% by weight of an alkyl dimethyl benzyl ammonium chloride wherein the alkyl contains
i) 40 to 60%, preferably 45 to 55% and most preferably about 50% of a C14 alkyl,
ii) 30 to 50%, preferably 35 to 45% by weight and most preferably about 40% by weight of a C12 alkyl, and
iii) 2 to 18% by weight, preferably 5 to 15% by weight and most preferably about 10% by weight of a C16 alkyl;
   b) 15 to 35%, preferably 20 to 30% and most preferably about 24% by weight of octyl decyl dimethyl ammonium chloride,
   c) 5 to 25%, preferably 8 to 16% and most preferably about 12% by weight of dioctyl dimethyl ammonium chloride
   d) 5 to 25%, preferably 8 to 16% and most preferably about 12% by weight of didecyl dimethyl ammonium chloride and
   e) 10 to 30% by weight, preferably 15 to 25% by weight, and most preferably about 20% by weight of water.

For Group II, an example would be alkyl dimethyl ethylbenzyl Quat with 68% C12 and 32% C14 alkyl chains. This is a mixture of two different alkyl chain groups C12 and C14.

For Group III, an example would be the alkyl dimethyl 3,4-dichlorobenzyl Quats.

The following preferred quaternary ammonium salts included but are not limited to cetyltrimethyl ammonium chloride, dioctyl dimethyl ammonium chloride, didecyl dimethyl ammonium chloride, octyl decyl dimethyl ammonium chloride, alkyl dimethyl benzyl ammonium chloride, alkyl diethyl benzyl ammonium chloride and mixtures thereof.

Some of the preferred mixtures include mixtures of

(a) dioctyl dimethyl ammonium chloride, didecyl dimethyl ammonium chloride and octyl decyl dimethyl ammonium chloride, and
(b) dioctyl dimethyl ammonium chloride, didecyl dimethyl ammonium chloride, octyl decyl dimethyl ammonium chloride and dimethyl benzyl ammonium chloride.

Specific examples approved by the EPA are as follows:

1)
12.5% by weight didecyl dimethyl ammonium chloride,
25.0% by weight octyl decyl dimethyl ammonium chloride, and
12.5% by weight dioctyl dimethyl ammonium chloride.
2)
20.0% by weight alkyldimethyl benzyl ammonium chloride (where the alkyl contains 50% C14,
40% C12 and 10% C16), (It is noted that this includes a mixture of C14 (14 carbons) C12 and C16 alkyls).
7.5% by weight didecyl dimethyl ammonium chloride,
15.0% by weight octyl decyl dimethyl ammonium chloride and
7.5% by weight dioctyl dimethyl ammonium chloride.
3)
SilverClear™ DG 300 which contains alkyl (50% of a C12 alkyl, 30% by weight of a C14 alkyl, 17% by weight of a C16 alkyl, 3% by weight of a C18 alkyl) dimethyl benzyl ammonium chloride (ADBAC)in an amount of 0.91% by weight, and silver nitrate in amount of 0.53% by weight, along with other ingredients in amount of 98.56% by weight.
4)
Alkyl (50% by weight of a C12 alkyl, 30% by weight of a C14 alkyl, 17% by weight of a C16 alkyl, 3% by weight of a C18 alkyl) dimethyl benzyl ammonium chloride (ADBAC) in an amount of 50% by weight and inert ingredients in an amount of 50% by weight.

In addition, mono or dialkyl tri or di(methyl and/or ethyl) ammonium halides wherein the alkyl is fatty alkyl containing from 6 to 18 carbon atoms, preferably cetyltrimethyl ammonium halides, where the halide is preferably chloride, bromide or iodide can be used. It is noted that each alkyl in the dialkyl can contain 6 to 18 carbon atoms. The quaternary ammonium salt is used in an amount from 0.5 to 25% by weight, preferably from 1 to 5% by weight, more preferably 1 to 3% by weight and most preferably about 1.3% by weight.

The most preferred cationic antimicrobials are as follows:

1) alkyl dimethyl benzyl ammonium chloride wherein the alkyl is about 50% by weight C12 alkyl, 30% by weight C14 alkyl, 17% by weight C16 alkyl and 3% by weight C18 alkyl,
2) alkyl diethyl benzyl ammonium chloride wherein the alkyl is about 50% by weight C12 alkyl, 30% by weight C14 alkyl, 17% by weight C16 alkyl and 3% by weight C18 alkyl,
3) cetyltrimethyl ammonium chloride and
4) a mixture comprising
a) 20 to 45% by weight, preferably 25 to 40% by weight, and most preferably about 32% by weight of an alkyl dimethyl benzyl ammonium chloride wherein the alkyl contains
i) 40 to 60% by weight, preferably 45 to 55% by weight, and most preferably about 50% by weight of a C14 alkyl,
ii) 30 to 50% by weight, preferably 35 to 45% by weight and most preferably about 40% by weight of a C12 alkyl, and
iii) 2 to 18% by weight, preferably 5 to 15% by weight and most preferably about 10% by weight of a C16 alkyl,
   b) 15 to 35% by weight, preferably 20 to 30% by weight and most preferably about 24% by weight of octyl decyl dimethyl ammonium chloride,
   c) 5 to 25% by weight, preferably 8 to 16% by weight, and most preferably about 12% by weight of dioctyl dimethyl ammonium chloride,
   d) 5 to 25% by weight, preferably 8 to 16% by weight, and most preferably about 12% by weight of didecyl dimethyl ammonium chloride and
   e) 10 to 30% by weight, preferably 15 to 25% by weight, and most preferably about 20% by weight of water.

### Dispersing Agent

To achieve a higher antimicrobial loading in a stable dispersion, the charge density could be increased by adding a highly charged, anionic polymer during the dispersion formation process. The dispersing agent is mixed with the anionic polyelectrolyte and the cationic antimicrobial. The dispersing agent is a highly charged, anionic polymer. The dispersing agent is added to achieve a higher antimicrobial loading in a stable dispersion.

We have found only certain dispersing agents work particularly well. One example of the dispersing agent includes a poly (acrylamide-co-acrylic acid). Preferably the poly (acrylamide-co-acrylic acid) is 20% by weight acrylamide, MW 200,000 because it has a high concentration of carboxyl groups in contrast to pure poly acrylic acid, and it forms a water insoluble complex with the cationic antimicrobial, such as cetyltrimethylammonium halide. It works well and the dispersion is stable over long periods of time (>six months). Another good dispersing agent is a copolymer of maleic acid and an olefin, and preferably the copolymer would have a molecular weight of about 10,000 to 14,000. One example, Sokalan® CP9, is from BASF and is a sodium salt of a copolymer of maleic acid and an olefin with about 12,000 MW.

The dispersing agent is present in the formulation at a concentration of from 0.05 to 6.25% by weight, preferably from 0.1 to 1% by weight and most preferably about 0.2% by weight to about 0.3% by weight. The dispersing agent can also be present in amount of 10 to 25% by weight of the amount of the cationic antimicrobial, and preferably about 14 to about 20% by weight of the amount of the cationic antimicrobial and most preferably about 14 to about 16% by weight of the amount of the cationic antimicrobial. For example, if the cationic antimicrobial is present in an amount of 2% by weight and the dispersing agent is 15% by weight of the cationic antimicrobial, it would be present in an amount of about 0.3% by weight relative to the weight of the dispersion.

### Water

The aqueous dispersion also contains water. The water is the balance of the dispersion. The water is present in an amount from 43 to 98% by weight, preferably from 89 to 97.9% by weight and most preferably 93.5 to 97.8% by weight.

### Processing Aids—Optional

Processing aids and formulating components such as wetting agents, colorants, anti-oxidants and other stabilizers, antistats, surfactants, rheology control agents, vitamins, botanical extracts, scents, odor control agents may also be employed. These can be present from 0 to 10% by weight, preferably from 0 to 5% by weight and most preferably from 0 to 2% by weight relative to the weight of the dispersion.

### Method of Preparation

Also provided is a method by which the present antimicrobial textiles are prepared as described above under Summary of the Invention.

Textiles comprised of fibers formed from synthetic polymers can be treated with the aqueous dispersion as described above.

The anionic polyelectrolytes, antimicrobial compounds and dispersing agents are mixed together to form an aqueous dispersion. The amount of anionic polyelectrolyte is from 0.5 to 25% by weight, preferably from 1 to 5% by weight, more preferably 1 to 3% by weight and most preferably about 1.3% by weight.

Quaternary ammonium salts, preferably mono or dialkyl tri or di(methyl and/or ethyl) ammonium halide is present in an amount from 0.5 to 25% by weight, preferably from 1 to 5% by weight, more preferably 1 to 3% by weight and most preferably about 1.3% by weight, and preferably the ratio of the amount of anionic polyelectrolyte to fatty alkyl or dialkyl tri or di(methyl and/or ethyl) ammonium halide from 0.85:1 to 1:0.85.

The dispersing agent range is from 0.05 to 6.25% by weight, preferably from 0.1 to 1% by weight and most preferably about 0.2 to 0.3% by weight. A preferred embodiment would have an amount that is about 1.3% by weight CMC salt, about 1.3% by weight cetyltrimethyl ammonium chloride or alkyl dimethyl benzyl ammonium chloride, 0.2% by weight dispersing agent, 97.2% by weight water.

The textile is treated with the aqueous solution such as by spraying, simple immersion or other coating method typically used in the textile coating industry. Any of the solutions or suspensions applied during processing steps may also include a processing aid such as an alcohol, wetting agent, surfactant, viscosity modifier, binding agent surface modifier, salts, pH-modifiers, etc.

As polypropylene and many other synthetic fibers are hydrophobic, it may in some cases be useful to modify the surface of the fibers to improve wetting so the aqueous solutions can be applied to the nonwoven fabric more quickly and evenly. Many methods are known in the art and include surface active additives like IRGASURF HL 560 or plasma surface treatment to add hydrophilic functionality to the surface of the fibers. Additionally, melt blending of additives with the synthetic polymer during formation of the fibers to impart hydrophilic functionality is possible.

For example, the antimicrobial textile wherein the synthetic polymer is polypropylene may comprise a surface active additive incorporated into the polypropylene before, after or during fiber extrusion.

One embodiment of the invention provides protective articles comprising a nonwoven composition comprising synthetic polymer fibers being treated with a dispersion containing quaternary ammonium compounds, anionic polyelectrolytes and the dispersing agent of the invention. Commercial articles produced using the compositions and methods of the invention include, among others, a protective article worn by patients, healthcare workers, or other persons who may come in contact with potentially infectious agents or microbes, including an article of clothing such as a gown, robe, face mask, head cover, shoe cover, or glove; alternatively, the protective article may include a surgical drape, surgical fenestration or cover, drape, sheets, bedclothes or linens, padding, gauze dressing, wipe, sponge and other antimicrobial articles for household, institutional, health care and industrial applications. In certain embodiments, the article contains the quaternary ammonium compounds and anionic polyelectrolytes on only one surface, for example the surface of a face mask which will face away from the body and possibly be exposed to pathogens. Nonwoven wipes are particularly embodied by the invention.

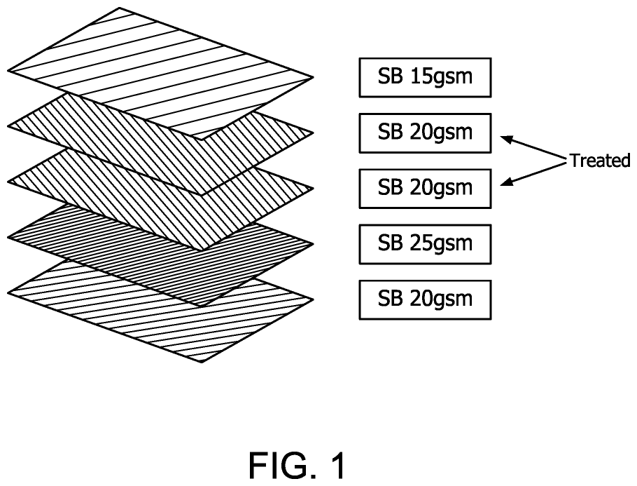

The nonwoven substrate material is normally a multi layered material. For example, an outer or inner fabric may be layered to another sheet ply, e.g., a filter or barrier media. In many embodiments, preferably not all of the other layers need to be treated with the present antimicrobial dispersion treatment. In one particular embodiment, only one layer of a layered polyolefin fabric is treated with the polyelectrolyte and antimicrobial. For example, spunbond meltblown spunbond (SMS) polypropylene fabrics which comprise a spunbond polypropylene (SB PP) layer on each face of a meltbound polypropylene layer are common in protective garments such as face masks and other disposable garments used in hospital settings. Often, only the surface of the fabric that faces away from the body, and exposed to contamination, is treated with an antimicrobial preparation. One embodiment of the invention relates to the treatment of only the “inner layers” of such materials and articles (see FIG. 1 where layers 2 and 3 from the top are treated with the aqueous dispersion).

The feel of a fabric, especially when held in close contact with the skin, is an important consideration, especially with synthetic fibers that may not be sufficiently soft or supple. Additives incorporated into the polypropylene fibers can improve the hydrophilicity of the fibers and impart a soft, comfortable feel to polypropylene nonwoven fabrics. The commercial product IRGASURF HL 560 is an example of this type of additive. It has been found that the polyelectrolyte and antimicrobial combination of the instant invention performs extremely well on fabrics treated with such products.

### Antimicrobial Barrier Mask

Personal protection can be achieved from two antimicrobially treated spunbond internal layers and the filtering effect from the meltblown layer.

This invention provides a leach resistant antimicrobial textile, preferably a nonwoven, a process for making such a fabric and an article comprising said fabric, e.g., a hospital gown, surgical drape or like product, that provides permanent, quick kill, antimicrobial capacity, yet the antimicrobial agent is not readily extracted (leached) from the textile in use.

These novel antimicrobial fabrics/textiles/compositions are superior to existing materials because the antimicrobial action is much quicker and thus far more effective in reducing the potential of transmitting harmful pathogens in a healthcare facility. The antimicrobial textile/composition exhibits at least a Log 4 colony-forming unit (CFU) reduction within a period of about 5 minutes after contact with various species of bacteria. The method of determining the antimicrobial activity is described below and is further detailed in modified American Association of Textile Chemists and Colorists (AATCC) 100 method (1998). The AATCC standard 100 method is modified only by shortening the contact time period to shorter increments, such as immediate and 5, 15 and 30 minute periods as detailed below. This method is referred to below in the application as the modified AATCC 100 method.

It is desired to construct a mask which is effective in trapping and quickly killing bacteria and viruses. The mask can be worn by healthcare professionals to help prevent the spread of harmful pathogens. In addition to being effective, the mask should also be comfortable to wear. It must not be too heavy or bulky, which would discourage its use for extended periods, and while offering effective filtration, it must have low air flow resistance so breathing is not labored.

The design of the disposable antimicrobial barrier mask is a multilayered construction consisting, from inside to out, of a spunbond layer, a meltblown barrier layer, two antimicrobial spunbond layers, topped with another spunbond layer (FIG. 1). These layers are stacked and bonded only around the edges so each layer can be treated separately.

We chose this construction because the treated layers are not exposed and there is no treatment of the meltblown layer, which would probably affect its filtration efficiency and air flow properties. The meltblown media is carefully designed to have high filtration efficiency with low flow resistance and any further treatment of this layer will undoubtedly affect this delicate balance. It was decided that the best application was to add a treated spunbond layer between the meltblown media and the outer layer. After weighing different options and some trial and error, it was found that using two antimicrobially treated lightweight PP spunbond nonwovens best balanced the need to keep the overall weight down and minimize effect on air flow resistance yet achieve high surface area of treated fibers to achieve high antimicrobial activity. The preferred weight of each layer is listed in FIG. 1. Each layer should have a weight range from 15-40 grams square meter (gsm or g/m²).

### EXAMPLES

The following procedures were used for Examples 1-12:

### Procedure 1 for Preparing Aqueous Dispersion

To 400 ml of a 2.0% by weight solution of CMC sodium salt (MW 90,000, DS=0.7), 1.2 g of poly(acrylamide-co-acrylic acid) (20% by weight acrylamide, MW 200,000) and 7 ml of 2N NaOH are added and mixed until dissolved. 200 mL of a 4% by weight solution of cetyltrimethylammonium chloride is then added to the well stirred solution over a 60 minute period. The reaction mixture is stirred for an addition 30 minutes and any coagulum formed is removed by passing the mixture through a 200 mesh screen.

### Procedure 2 for Treating Nonwoven

For treating the nonwoven with the coating, the nonwoven is cut into 9 inch×9 inch squares. The formulation containing the dispersion with active is diluted with water (25:75). After dilution, an Atlas padder is used to treat the nonwoven squares. The coating is performed until the desired active weight pickup is obtained. After treatment, the samples are hung in the hood on a copper wire for drying. When visibly dry, the samples are then dried in an oven at 80° C. for 1 hour.

### Procedure 3 Determining the Antimicrobial Activity for Treated Nonwovens

The antimicrobial activity of the treated nonwoven is determined by evaluating 3 inch×3 inch squares. The test method used is the modified AATCC 100 method referred to above, that evaluates textile materials for antimicrobial activity. In this test, the sample is evaluated for antimicrobial activity by inoculation with a defined cell count of a specific test organism. Microbial solutions are absorbed by textile materials and after a defined incubation period the antimicrobial is deactivated, and the microbial cells are washed from the fabric. With dilution and plating the concentration of surviving microbes can be enumerated. When compared to untreated controls, the reduction in microbial concentration, typically reported in logarithmic form, is determined. Since a quick killing effect is essential for our application, an immediate, 5 minute and 30 minute contact time is typically used.

TABLE 1
Examples 1-12 Activity Against Klebsiella pneumoniae

| | | Log Reduction |
|---|---|---|
| | | Contact time: |
| | | 5 minutes |
| Example | | Klebsiella |
| # | Description | pneumoniae/G− |
| 1 | 0.25% by weight active on SB PP | 5.0 |
| | nonwoven | |
| 2 | 0.50% by weight active on SB PP | 4.0 |
| | nonwoven | |
| 3 | 1.0% by weight active on SB PP | 3.5 |
| | nonwoven | |
| 4 | 0.12% by weight active on S-tex | 3.2 |
| | nonwoven | |
| 5 | 0.20% by weight active on S-tex | 2.6 |
| | nonwoven | |
| 6 | 0.25% by weight active on S-tex | 3.7 |
| | nonwoven | |
| 7 | 0.4% by weight active on S-tex | 2.9 |
| | nonwoven | |
| 8 | 0.5% by weight active on S-tex | 4.5 |
| | nonwoven | |
| 9 | 1.0% by weight active on S-tex | 4.2 |
| | nonwoven. | |
| 10 | 1.5% by weight active on S-tex | 5.0 |
| | nonwoven | |
| 11 | 0.25% by weight active on S-tex | 3.7 |
| | nonwoven. Dispersion contained | |
| | anti-foaming agent BYK ® 012 | |
| 12 | Material from Crosstex ® medical | 0 |
| | face mask treated with Biosafe ® | |
| | Antimicrobial Protection | |

Example 1 is prepared using dispersion Procedure 1 as described above, applied using application Procedure 2 as described above to give 0.25% by weight coating relative to the weight of an SB PP nonwoven. The SB PP nonwoven used in examples 1-3 is Fitesa 17 gsm high uniformity spunbond nonwoven made by Fiberweb. Antimicrobial activity is determined as that described in Procedure 3, for Klebsiella pneumoniae.

Example 2 is the same as Example 1 except at 0.5% by weight.

Example 3 is the same as Example 1 except at 1.0% by weight.

Example 4 is the same as Example 1 except at 0.12% by weight coating relative to the weight of an S-tex nonwoven. The S-tex used in examples 4-11 is 20 gsm spunbond nonwoven made by Fiberweb.

Example 5 is the same as Example 4 except at 0.20% by weight.

Example 6 is the same as Example 4 except at 0.25% by weight.

Example 7 is the same as Example 4 except at 0.4% by weight.

Example 8 is the same as Example 4 except at 0.5% by weight.

Example 9 is the same as Example 4 except at 1.0% by weight.

Example 10 is the same as Example 4 except at 1.5% by weight.

Example 11 is the same as Example 6 except the dispersion contained anti-foaming agent BYK® 012.

Example 12 is material from a commercial Crosstex® medical face mask treated with Biosafe® Antimicrobial Protection.

### Example 13

### Procedure for Preparing Pilot Batch of Antimicrobial Dispersion

The dispersion is prepared by adding CMC sodium salt (1.31 lbs) to distilled water (64.3 lbs). The poly(acrylamide co-acrylic acid) (0.197 lbs) is then added followed by the 2N NaOH (1.24 lbs). This mixture is then agitated until completely homogeneous. During the whole batch, the jacket temperature in the vessel was controlled at 70° F. After approximately 5 hours, the mixture was almost completely homogeneous and transparent. Cetyltrimethylammonium chloride solution (5.26 lbs) along with distilled water (26.6 lbs) is fed over 60 minutes using agitation. After the feed was completed, mixing is continued for 30 more minutes. The product is then filtered thru a 125 micron cartridge filter (Parker Fulflo Probound 125) to give 12 gallons (˜100 lbs) of material.

Using the process detailed above, a stable aqueous dispersion is produced. One sample was stored for six months and the particle size distribution was monitored. Only minor change in the particle size distribution was noted over the six-month period.

Treating the S-TEX nonwoven with Antimicrobial Dispersion

A substrate to be treated is from S-tex nonwoven, a lightweight (20 gsm) PP spunbond fabric from Fiberweb (160 cm×1,500 m). The fabric is saturated by passing the fabric through a trough containing the dispersion prepared using the above pilot batch procedure. The excess is removed by passing the saturated fabric through rollers. The fabric was dried on-line. The targeted loading levels are 0.5% and 1.0% active, and from the preliminary work done and a wet pickup of about 140% is expected. It turned out that the pickup is only 70%, so in the first run using a 50% dilution of the dispersion only a 0.5% loading level is achieved instead of the expected 1%. The treatment ran smoothly and over 300 meters of treated fabric was produced. For the material in the second run, the dispersion is used at full strength, but this led to foaming issues which lowered the wet pickup to 44% and as a result only a 0.6% loading level, not the desired 1%, is achieved. For both treatment levels the feel of the treated fabric is almost indistinguishable to the untreated fabric.

### Antimicrobial Testing

The commercially treated nonwoven fabric is evaluated using the same modified AATCC 100 method used above. Short contact times, 0, 5 and 30 minutes, are used. We chose four clinically relevant bacteria (two Gram Positive and two Gram Negative) to evaluate: Methicillin-resistant Staphylococcus aureus (MRSA)/G+ (ATCC BAA 811), Klebsiella pneumoniae/G-(ATCC51504), Streptococcus pneumoniae/G+ (ATCC BAA 659) and Pseudomonas aeruginosa/G-(ATCC BAA 2108). The results are summarized in

### Table 2.

TABLE 2
Antimicrobial Quick Kill Results on Nonwovens
0.5% Actives

| | Contact | Contact | Contact |
|---|---|---|---|
| | time: | time: | time: |
| Pathogen | 0 min | 5 min | 30 min |
| MRSA | Log 5 | Log 5 | |
| Klebsiella pneumoniae | <1 | Log 5 | |
| Streptococcus pneumoniae | Log 5 | Log 5 | |
| Pseudomonas aeruginosa | — | Log 3 | Log 5 |

The level of activity is excellent. Methicillin-resistant Staphylococcus aureus (MRSA), Klebsiella pneumonia and Streptococcus pneumonia showed Log 5 reduction after 5 minutes, while Pseudomonas aeruginosa, which has a higher tolerance to cationic antimicrobial agents, showed Log 3 reduction after 5 minutes and Log 5 reduction after 30 minutes. In two examples, the killing is almost instantaneous, as a Log 5 reduction occurred during the time it takes to inoculate then deactivate the sample.

### Zone of Inhibition Test

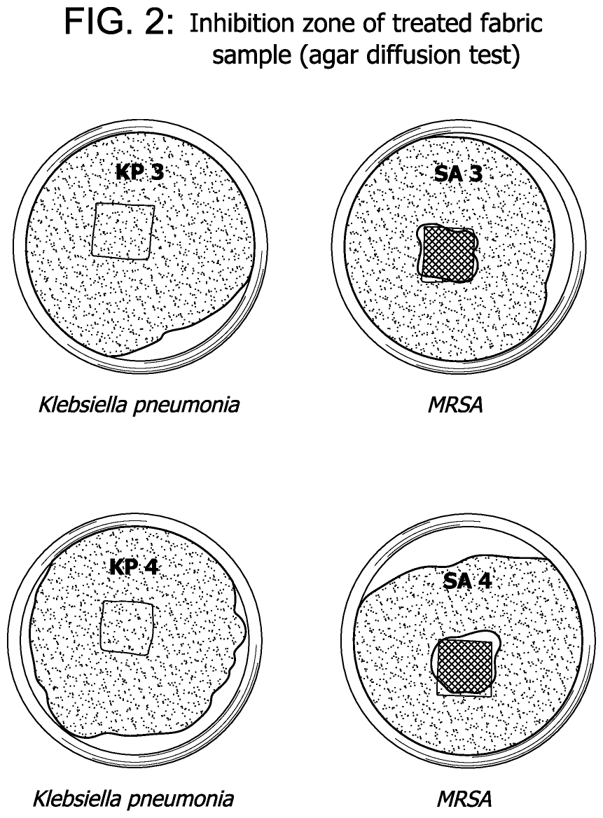

In this test, after inoculation with the test bacteria, the fabric samples are placed on nutrient agar plates and incubated for 24 hours. The plates are then examined for bacterial growth under and around the edges of the fabric (zone of inhibition). The fabric samples inoculated with Klebsiella pneumonia showed no zone of inhibition while the samples inoculated with Methicillin-resistant Staphylococcus aureus (MRSA) gave a small clear outline that was not measurable. This test indicates that there is very little leaching of the cationic antimicrobial from the treated fabric even after 24 hours, which is evident from no significant zone of inhibition being observed. This effect is shown in FIG. 2.

### Antiviral Testing

The organisms evaluated were Influenza A virus (H1N1), Bovine Viral Diarrhea Virus (surrogate for Hepatitis C) and Rhinovirus. The virucidal efficacy test for treated fabric material is done according to the modified AATCC 100 method described above. The treated nonwoven and a control nonwoven (treated with CMC sodium salt only) were evaluated against the challenge virus using a misting challenge procedure for inoculation. The virus is misted onto the test sample (3 inches×3 inches) and held for two exposure times (5 min and 30 min). The surviving virus is extracted by placing the fabric into a stomach bag with a recovery medium (neutralizer) then stomached to elute the virus. The extracted sample is then serially diluted and inoculated onto the host cells to determine the amount of surviving infectious virus.

TABLE 3
Antiviral Results

| | Log Reduction | |
|---|---|---|
| | Contact Time | |
| Virus | 5 Minutes | 30 Minutes |
| Influenza A (H1N1) | Log 3 | Log 3 |
| (2009 pandemic strain) | | |
| Bovine Viral Diarrhea | Log 1 | Log 3 |
| (Surrogate for Human | | |
| Hepatitis C) | | |
| Rhinovirus | <Log 1 | <Log 2 |

The results show that the treated nonwoven has good activity against Influenza A Virus (H1N1), slightly less activity against Bovine Viral Diarrhea and little activity against Rhinovirus. This order is expected because envelope viruses are easier to inactivate compared to non-envelope viruses.

The treated spunbond nonwoven has excellent antimicrobial and significant anti-viral properties while the tactile feel remains essentially unchanged.

The following other dispersing agents (Sokalan® products) were evaluated relative to physical properties and filtration without phase separation:

TABLE 4
Sokalan ® products

| Water soluble | Chemistry | Conc. | Molar mass | | Viscosity |
|---|---|---|---|---|---|
| polymers (liquid) | (Na salt) | (%) | (g/mol) | pH | (mPa · s) |
| Sokalan ® PA | Polyacrylic acid | 35 | 250000 | 2 | 5000 |
| 110S | | | | | |
| Sokalan ® PA | Polyacrylic acid | 45 | 15000 | 8 | 1000 |
| 30 CL | | | | | |
| Sokalan ® PA | Polyacrylic acid | 54 | 4000 | 4 | 1700 |
| 25 CLPN | | | | | |
| Sokalan ® CP 9 | Maleic acid/olefin | 25 | 12000 | 11 | 50 |
| | copolymer | | | | |
| Sokalan ® CP 45 | Maleic acid/acrylic | 45 | 70000 | 4 | 8000 |
| | acid copolymer | | | | |
| Sokalan ® CP 5 | Maleic acid/acrylic | 40 | 70000 | 8 | 2000 |
| | acid copolymer | | | | |

Dispersions are prepared using the experimental procedure 1 above and adjusting the amount of dispersing agent to give 15% by weight relative to amount of cetyltrimethyl ammonium chloride for each product evaluated. In the examples, the amount of cetyltrimethyl ammonium chloride was 2% by weight and the amount of the Sokalan® products are 0.3% by weight. Sokalan® products were used instead of poly(acrylamide-co-acrylic acid) as the dispersing agent.

TABLE 5
Data for formulations prepared with Sokalan ® products

| Dispersing Agent | Viscosity@ | Particle | | Filtering | Separation |
|---|---|---|---|---|---|
| 0.3% by weight | 50 RPM(cP) | size | pH | speed | over time |
| Sokalan ® PA 110S | 7 | 48 | 4.7 | medium | yes |
| Sokalan ® PA 30 CL | 268 | 8 | 7.2 | slow | no |
| Sokalan ® PA 25 | 23 | 83 | 4.7 | fast | yes |
| CLPN | | | | | |
| Sokalan ® CP 9 | 142 | 20 | 10.5 | slow | no |
| Sokalan ® CP 45 | 136 | 5 | 5.0 | medium | no |
| Sokalan ® CP 5 | 260 | 86 | 7.7 | slow | no |

Sokalan® CP 9 is the sole Sokalan® dispersing agent not requiring pH adjustment by NaOH addition. The other two formulations (CP 5 and CP45) were not stable over longer periods of time.

TABLE 6
Comparison of Sokalan ® products with >pH 10 to
poly(acrylamide-co-acrylic acid)

| Dispersing Agent | Viscosity | | | |
|---|---|---|---|---|
| Percent by % by | @50 RPM | | Filtering | Separation |
| weight—0.3 | (cP) | pH | speed | over time |
| Sokalan ® CP 9 | 142.2 | 10.5 | slow | no |
| Sokalan ® CP 45 | 41.4 | 10.8 | medium | yes |
| Sokalan ® CP 5 | 129.6 | 10.2 | very slow | yes |
| Poly(acrylamide-co- | 60.9 | 11.93 | medium | no |
| acrylic acid) | | | | |

Sokalan® CP 9 without separation is the best dispersion polymer of the evaluated Sokalan® polymers.

Antimicrobial dispersion is prepared by mixing 400 ml of a 2.0% by weight solution of carboxymethyl cellulose sodium salt (MW 90,000, DS=0.7) with 1.2 g of Sokalan® CP 9 polymer with mechanical stirrer until dissolved. 200 mL of a 4% by weight solution of cetyltrimethylammonium chloride is then added to the well stirred solution over a 60 minute period. The pH should be checked and the pH should be about 10.5. If necessary, 2N NaOH is added carefully to adjust pH to about 10.5. This mixture is stirred for an additional 30 minutes and any coagulum was removed by passing the mixture through a 100 mesh screen.

For treating the nonwoven, the same Procedure 2 is used as in Examples 1-11. The nonwoven is cut into 9 inch×9 inch squares. The formulation containing the dispersion with active is diluted with water (50:50). After dilution, an Atlas padder is used to treat the nonwoven squares. After treatment, the samples are hung in the hood on a copper wire for drying. After being visibly dry, the samples are then dried in an oven at 80° C. for 1 hr. After drying the loading of the coating was determined to be 1.3% and 0.6% active.

The antimicrobial activity of the treated nonwoven is determined by evaluating 3 inch×3 inch squares. The test method used is a modified AATCC 100 method that evaluates textile materials for antimicrobial activity as described previously in procedure 3. Antimicrobial efficacy was evaluated using Methicillin-resistant Staphylococcus aureus (MRSA) and Klebsiella pneumoniae after 5 minutes. The results are shown in Table 7.

TABLE 7
Antimicrobial data for Sokalan ® CP 9 dispersion

| Pathogen | Contact time: 5 minutes |
|---|---|
| MRSA/G+ | Log 5 |
| Klebsiella pneumoniae/G− | Log 3 |

The results are comparable to the level of quick kill activity previously seen with lab scale treated nonwovens at 0.5% active loading.

### Example 14

### Fabrication of Antimicrobial Face Mask

### Spunbond Treatment

The PP spunbond treatment is done by a combination of anionic polyelectrolyte CMC sodium salt with the cationic antimicrobial cetyltrimethylammonium chloride. The two form a water insoluble polyelectrolyte complex which has affinity to the hydrophobic polyolefin fibers. The substrate is S-tex, a lightweight (20 gsm) spunbond fabric from Fiberweb made from bicomponent PE/PP fibers. Samples were first treated with an aqueous solution of CMC sodium salt (average MW 90,000; degree of substitution 0.7) containing 10% isopropanol to improve wetting. The wet pickup of the spunbond is about 200%, so the loading is adjusted by changing the concentration of CMC sodium salt in solution and measuring the wet pickup gravimetrically. The antimicrobial agent, cetyltrimethylammonium chloride, is then added in a second application step using the same applicator. The level of antimicrobial is also adjusted by varying the concentration of the aqueous solution and measuring the wet pickup. It was targeted that the level of CMC sodium salt would be slightly higher (˜10%) than the cetyltrimethylammonium chloride.

Four loadings are prepared: 1%, 0.75%, 0.5% and 0.25% of actives. The loading levels are stepped down so that a minimal effective loading could be determined. Five layered panels containing the two treated spunbond layers are constructed as depicted in FIG. 1. These panels were then evaluated for their antimicrobial effect.

### Antimicrobial Testing

The mask panels are evaluated using a modified Japanese Industrial Standards (JIS) L 1902 bacteria testing protocol. Short contact times, 5 and 30 minutes, are used with the following four clinically relevant bacteria (two Gram Positive and two Gram Negative) to evaluate: Methicillin-resistant Staphylococcus aureus (MRSA)/G+ (ATCC BAA 811), Klebsiella pneumoniae/G-(ATCC51504), Streptococcus pneumoniae/G+ (ATCC BAA 659) and Pseudomonas aeruginosa/G-(ATCC BAA 2108). All the organisms are multidrug resistant clinical isolates and are expected to be more difficult to kill than the standard strains. The results are summarized in Table 8.

TABLE 8
Five Minute Quick Kill Results for Four Pathogens

| | Active Loading | | | |
|---|---|---|---|---|
| Pathogen | 1.0% | 0.75% | 0.5% | 0.25% |
| MRSA/G+ | | Log 5 | | Log 5 |
| Klebsiella pneumoniae/G− | Log 4 | Log 4 | Log 3 | Log 3 |
| Streptococcus pneumoniae/G+ | | Log 5 | | Log 5 |
| Pseudomonas aeruginosa/G− | <Log 1 | | <Log 1 | |

Extremely high activity is measured against three of the four organisms. Even at active loadings as low as 0.25%, a Log 5 reduction is observed against MRSA, one of the principle bacteria involved in hospital acquired infections. The low activity against P. aeruginosa, is not completely unexpected as it is known not to be as sensitive to cationic antimicrobial agents.

### Example 15

### Benchmarking Against Commercial Antimicrobial Masks

Comparison is made with commercial Crosstex and Nexera materials and with the inventive treated mask material. Treated spunbond nonwoven (containing 0.5% by weight cetyltrimethylammonium chloride) from Example 13 is used in the two treated layers in FIG. 1. The same test method as described in Procedure 3 is used. After 5-minute exposure, the inventive treated mask is significantly more active. The comparisons are shown in Table 9. Only one organism was tested against the Nexera material since it was expected that the silver and copper antimicrobials present in Nexera will not be active with short contact times.

TABLE 9
Comparison of antimicrobial mask material.
Log reduction of microorganism after 5 minutes.

| Pathogen | Inventive Mask | Crosstex | Nexera |
|---|---|---|---|
| MRSA/G+ | Log 4 | <Log 1 | |
| Klebsiella pneumoniae/G− | Log 5 | <Log 1 | <Log 1 |
| Streptococcus pneumoniae/G+ | Log 4 | Log 2 | |
| Pseudomonas aeruginosa/G− | <Log 1 | <Log 1 | |

No activity was measured for the Crosstex mask against these four organisms even after 30 minutes contact time. Further evaluations showed no activity after 24 hours against Pseudomonas aeruginosa, Candida albicans and Aspergillus niger.

With the results to date there is a clear differentiation between the inventive quick kill treatment and the commercial alternatives.

### Procedure for Preparing the Dispersion of Examples 16-20

To 400 ml of a 2.0% by weight solution of CMC sodium salt (MW 90,000, DS=0.7), is added 1.2 g of Sokalan® CP 9 polymer and mixed with mechanical stirrer until dissolved. 200 mL of a 4% by weight solution of quaternary ammonium antimicrobial agent (from examples 16-20) is then added to the well stirred solution over a 60 minute period. Check pH, pH should be about 10.5. If necessary, 2N NaOH is added carefully to adjust pH to about 10.5. This mixture is stirred for an additional 30 minutes and any coagulum was removed by passing the mixture through a 100 mesh screen.

Example 16 contains active cetyltrimethylammonium chloride 100%.

Example 17 contains active alkyl (50% C14, 40% C12, 10% C16) dimethyl benzyl ammonium chloride 32.0% by weight, octyl decyl dimethyl ammonium chloride 24.0% by weight, dioctyl dimethyl ammonium chloride 12.0% by weight, didecyl dimethyl ammonium chloride 12.0% by weight, inert ingredients 20% by weight.

Example 18 contains active didecyl dimethyl ammonium chloride 48.0% by weight, Alkyl (50% by weight C14, 40% by weight C12, 10% by weight C16) contains active dimethyl benzyl ammonium chloride 32% by weight, inert ingredients 20% by weight.

Example 19 contains active didecyldimethylammonium chloride 80% by weight, inert ingredients 20% by weight.

Example 20 contains active alkyl (50% by weight C12, 30% by weight C14, 17% by weight C16, 3% by weight C18) dimethyl benzyl ammonium chloride 50.0% by weight, inert ingredients 50% by weight.

For treating the nonwoven with the dispersion, the nonwoven is cut into 9 inch×9 inch squares. The formulation containing the dispersion with active is diluted with water (25:75). After dilution, the solution is poured into a 9×13 inch glass baking dish. The nonwoven cut squares are submerged in the dish. A weighted roller is used to completely cover/impregnant nonwoven until the desired active weight pickup is obtained. The squares are removed and hung by clips from a wire rack and air dry in the hood for 30 minutes. After 30 minutes the squares are placed in a 80° C. oven for an additional 1 hour of drying.

The antimicrobial activity of the treated nonwoven is determined by evaluating 3 inch×3 inch squares. The test method used is the modified AATCC 100 method that evaluates textile materials for antimicrobial activity as described previously in Procedure 3. Antimicrobial efficacy was evaluated using MRSA and Klebsiella pneumoniae after 5, 15 or 30 minutes.

Example 16 was evaluated against SARS CoV-2. The virucidal efficacy test for treated fabric material is done according to the modified AATCC 100 method described above. The treated nonwoven and a control nonwoven (treated with CMC only) are evaluated against the challenge virus using a misting challenge procedure. The virus is misted onto the test sample (3 inches×3 inches) and held for two exposure times (5 min and 15 min). The surviving virus is extracted by placing the fabric into a stomach bag with a recovery medium (neutralizer) then stomached to elute the virus. The extracted sample is then serially diluted and inoculated onto the host cells to determine the amount of surviving infectious virus.

TABLE 10
Comparison of results using dispersing polymer Sokalan ® CP 9 with different
active ingredients. Results expressed as % reduction relative to control untreated nonwoven.

| | Non- | | | | | | | | SARS | SARS |
|---|---|---|---|---|---|---|---|---|---|---|
| | woven | Active | MRSA | MRSA | MRSA | K.p. | K.p. | K.p. | CoV 2 | CoV 2 |
| Ex | g/m² | dry wt. % | (5 min) | (15 min) | (30 min) | (5 min) | (15 min) | (30 min) | (5 min) | (15 min) |
| 16 | 37 | 1.14 | 99+% | — | 99.999% | 99.999% | — | 99.999% | ≥98% | ≥98% |
| 17 | 37 | 2.6 | 99.999% | — | 99.999% | — | — | — | — | — |
| 18 | 37 | 2 | 99.999% | — | 99.999% | — | — | — | — | — |
| 19 | 37 | 3 | 99.999% | — | 99.999% | — | — | — | — | — |
| 20 | 37 | 0.53 | — | 99.999% | — | — | 99.999% | — | — | — |

Very good activity is observed for example 16 against SARS CoV-2 even at short time exposure of 5 minutes. All the examples showed extremely good activity against the bacterial strains tested at an exposure time of 5, 15 or 30 minutes.

### SUMMARY

The treated spunbond nonwoven has excellent antimicrobial and significant anti-bacterial and anti-viral properties while the tactile feel remains essentially unchanged. The cost-effective antimicrobial technology is a stable aqueous dispersion of the mixture of the anionic polymer carboxymethylcellulose and the cationic antimicrobial cetyltrimethylammonium chloride or ADBAC. For a commercially viable process, the binder (dispersing agent), CMC salt, and the antimicrobial needed to be formulated into a stable aqueous dispersion.

Using the antimicrobial treatment for synthetic nonwovens according to the invention, we can construct a barrier mask with high antimicrobial activity. The mask is far more effective than the antimicrobial mask which are currently available commercially.

All references disclosed herein are incorporated by reference. Although specific embodiments have been illustrated and described herein for purposes of description of the preferred embodiments, it will be appreciated by those of ordinary skill in the art that a wide variety of alternate or equivalent implementations calculated to achieve the same purposes may be substituted for the specific embodiments shown and described without departing from the scope of the present invention. This application is intended to cover any adaptations or variations of the preferred embodiments discussed herein. Therefore, it is manifestly intended that this invention be limited only by the claims and the equivalents thereof.

1-54. (canceled)

55. An aqueous dispersion which comprises
a) 0.5 to 25% by weight of one or more of an anionic polyelectrolyte,
b) 0.5 to 25% by weight of one or more of a quaternary ammonium salt,
c) 0.05 to 6.25% by weight of a dispersing agent, wherein the dispersing agent is poly(acrylamide-co-acrylic acid) or a copolymer of maleic acid and an olefin and
d) 43 to 99% by weight of water.

56. The aqueous dispersion as claimed in claim 55, wherein the one or more anionic polyelectrolyte comprises a carboxymethyl cellulose (CMC) salt and the one or more quaternary ammonium salt comprises one or more of
(i) a mono or dialkyl tri or di(methyl and/or ethyl) ammonium halide, and
(ii) an alkyl di(methyl and/or ethyl) benzyl ammonium halide,
wherein the alkyl or each alkyl contains 6 to 18 carbon atoms.

57. The aqueous dispersion as claimed in claim 56, wherein
the mono or dialkyl tri or di(methyl and/or ethyl) ammonium halide is cetyltrimethyl ammonium chloride or
the alkyl di(methyl and/or ethyl) benzyl ammonium halide is alkyl dimethyl benzyl ammonium chloride and
the one or more anionic polyelectrolyte comprises a carboxymethyl cellulose (CMC) salt.

58. The aqueous dispersion as claimed in claim 57, wherein the aqueous dispersion comprises
1 to 3% by weight of the CMC sodium salt,
1 to 3% by weight of the alkyl dimethyl benzyl ammonium chloride or cetyltrimethyl ammonium chloride,
0.15 to 0.45% by weight of the dispersing agent and
93.5 to 97.8% by weight of water and
wherein the ratio of the alkyl dimethyl benzyl ammonium chloride or cetyltrimethyl ammonium chloride, to the CMC sodium salt is about 1:1.

59. The aqueous dispersion as claimed in claim 58, wherein the alkyl dimethyl benzyl ammonium chloride is present in an amount between 1 and 5% by weight, and the alkyl of said alkyl dimethyl benzyl ammonium chloride is about 50% by weight C12 alkyl, 30% by weight C14 alkyl, 17% C16 by weight alkyl and 3% by weight C18 alkyl.

60. The aqueous dispersion as claimed in claim 56, wherein the aqueous dispersion comprises
1 to 3% by weight of the CMC sodium salt,
1 to 3% by weight of a mixture of quaternary ammonium salts,
0.15 to 0.45% by weight of the dispersing agent and
93.5 to 97.8% by weight of water, and
wherein the mixture of quaternary ammonium salts comprises
a) 20 to 45% by weight of an alkyl dimethyl benzyl ammonium chloride, wherein the alkyl contains
i) 40 to 60% by weight, of a C14 alkyl,
ii) 30 to 50% by weight, of a C12 alkyl, and
iii) 2 to 18% by weight, of a C16 alkyl;
b) 15 to 35% by weight of octyl decyl dimethyl ammonium chloride,
c) 5 to 25% by weight of dioctyl dimethyl ammonium chloride and
d) 5 to 25% by weight of didecyl dimethyl ammonium chloride.

61. A process to make the aqueous dispersion as claimed in claim 55, which comprises mixing the following components:
a) 0.5 to 25% by weight of one or more of an anionic polyelectrolyte with
b) 0.5 to 25% by weight of one or more of a quaternary ammonium,
c) 0.05 to 6.2% by weight of a dispersing agent, wherein the dispersing agent is poly(acrylamide-co-acrylic acid) or a copolymer of maleic acid and an olefin and
d) 43 to 99% by weight of water.

62. The process as claimed in claim 61, wherein the one or more of the anionic polyelectrolyte comprises a carboxymethyl cellulose (CMC) salt, and
the one or more of the quaternary ammonium salt comprises one or more of
(i) a mono or dialkyl tri or di(methyl and/or ethyl) ammonium halide wherein the alkyl or each alkyl contains 6 to 18 carbon atoms and
(ii) an alkyl di(methyl and/or ethyl) benzyl ammonium halide,
wherein the alkyl contains 6 to 18 carbon atoms.

63. The process as claimed in claim 62, wherein
the mono or dialkyl tri or di(methyl and/or ethyl) ammonium halide is cetyltrimethyl ammonium chloride or
the alkyl di(methyl and/or ethyl) benzyl ammonium halide is alkyl dimethyl benzyl ammonium chloride,
and the one or more of the anionic polyelectrolyte comprises a carboxymethyl cellulose (CMC) salt.

64. The process as claimed in claim 63, wherein the aqueous dispersion comprises
1 to 3% by weight of the CMC sodium salt,
1 to 3% by weight of the alkyl dimethyl benzyl ammonium chlorideor cetyltrimethyl ammonium chloride,
0.15 to 0.45% by weight of the dispersing agent and
93.5 to 97.8% by weight of water
wherein the ratio of the alkyl dimethyl benzyl ammonium chloride or cetyltrimethyl ammonium chloride,to the CMC sodium salt is about 1:1.

65. The process as claimed in claim 64, wherein the alkyl dimethyl benzyl ammonium chloride is present in an amount between 1 and 5% by weight, and the alkyl of said alkyl dimethyl benzyl ammonium chloride is about 50% by weight C12 alkyl, 30% by weight C14 alkyl, 17% C16 by weight alkyl and 3% by weight C18 alkyl.

66. The process as claimed in claim 65, wherein the aqueous dispersion comprises
1 to 3% by weight of the CMC sodium salt,
1 to 3% by weight of a mixture of quaternary ammonium salts,
0.15 to 0.45% by weight of the dispersing agent and
93.5 to 97.8% by weight of water,
wherein the mixture of quaternary ammonium salts comprises
a) 20 to 45% by weight of an alkyl dimethyl benzyl ammonium chloride, wherein the alkyl contains
i) 40 to 60% by weight, of a C14 alkyl,
ii) 30 to 50% by weight, of a C12 alkyl, and
iii) 2 to 18% by weight, of a C16 alkyl;
b) 15 to 35% by weight of octyl decyl dimethyl ammonium chloride,
c) 5 to 25% by weight of dioctyl dimethyl ammonium chloride and
d) 5 to 25% by weight of didecyl dimethyl ammonium chloride.

67. A multilayer substrate which comprises at least layers: a top layer, a bottom layer and at least one inner layer between said top layer and said bottom layer, wherein said at least one inner layer is coated with the dispersion as claimed in claim 55.

68. The multilayer substrate as claimed in claim 67, wherein the at least three layers are at least five layers and the layers are polypropylene nonwoven layers.

69. A mask to protect against nosocomial infections, bacteria, fungi, yeast or viruses which comprises at least five layers: a top layer, a bottom layer and at least three inner layers between said top layer and said bottom layer, wherein at least one of said at least three inner layers is coated with the dispersion as claimed in claim 55.

70. An article which is coated or sprayed with the dispersion as claimed in claim 55, wherein the article is a hospital gown, surgical equipment, medical device, glove, mask or bed clothes.

71. A process to make a treated textile material that is effective against nosocomial infections, bacteria, fungi, yeast or viruses which comprises applying in a single step application the dispersion as claimed in claim 55 by coating or spraying on the textile material.

72. The process as claimed in claim 71, wherein the textile material is a hospital gown, surgical equipment, medical device, glove or mask or bed clothes.

73. The process as claimed in claim 71, wherein the textile material comprises nonwoven polypropylene.

74. A process for protecting a person against nosocomial infections, bacteria, fungi, yeast or viruses which comprises contacting the person with the article as claimed in claim 70.

75. The process as claimed in claim 74, wherein the virus is SARS-CoV-2.

76. An active antimicrobial treatment which comprises coating a synthetic nonwoven fabric with the dispersion as claimed in claim 55, such that when bacteria, fungi, yeast or viruses comes in contact with the coated fabric, at least a Log 4 reduction in viable bacterial count occurs within 5 minutes of inoculation.

77. An article comprising a fabric which comprises a fiber or textile which is treated with a dispersion comprising an alkyl dimethyl benzyl ammonium chloride or alkyl diethyl benzyl ammonium chloride,
an anionic polyelectrolyte and
water.

78. The article of as claimed in claim 77, wherein the alkyl in said alkyl dimethyl benzyl ammonium chloride is about 50% by weight C12 alkyl, 30% by weight C14 alkyl, 17% by weight C16 alkyl and 3% by weight C18 alkyl.

79. An article comprising a fabric which comprises a fiber or textile which is treated with a dispersion comprising
a mixture of quaternary ammonium salts,
an anionic polyelectrolyte and
water,
wherein the mixture of quaternary ammonium salts comprises
a) 20 to 45% by weight of an alkyl dimethyl benzyl ammonium chloride wherein the alkyl contains
i) 40 to 60% by weight of a C14 alkyl,
ii) 30 to 50% by weight of a C12 alkyl, and
iii) 2 to 18% by weight of a C16 alkyl;
b) 15 to 35% by weight of octyl decyl dimethyl ammonium chloride,
c) 5 to 25% by weight of dioctyl dimethyl ammonium chloride and
d) 5 to 25% by weight of didecyl dimethyl ammonium chloride.

80. An aqueous dispersion consisting essentially of
from about 0.1 to 0.3% by weight of a dispersing agent, wherein the dispersing agent,
from about 1.3 to 1.4% by weight of carboxymethyl cellulose (CMC) salt,
from about 1.3 to 1.4% by weight of quaternary ammonium salts, and
water,
wherein the quaternary ammonium salt is selected from the group consisting of
1) an alkyl dimethyl benzyl ammonium chloride wherein the alkyl is about 50% by weight C12 alkyl, 30% by weight C14 alkyl, 17% by weight C16 alkyl and 3% by weight C18 alkyl, and
2) an alkyl diethyl benzyl ammonium chloride wherein the alkyl is about 50% by weight C12 alkyl, 30% by weight C14 alkyl, 17% by weight C16 alkyl and 3% by weight C18 alkyl,
3) a cetyltrimethyl ammonium chloride and
4) a mixture comprising
a) 20 to 45% by weight of an alkyl dimethyl benzyl ammonium chloride wherein the alkyl contains
i) 40 to 60% by weight of a C14 alkyl,
ii) 30 to 50% by weight of a C12 alkyl, and
iii) 2 to 18% by weight of a C16 alkyl;
b) 15 to 35% by weight of octyl decyl dimethyl ammonium chloride,
c) 5 to 25% by weight of dioctyl dimethyl ammonium chloride,
d) 5 to 25% by weight of didecyl dimethyl ammonium chloride and
e) 10 to 30% by weight of water.
